(19) United States
(12) Patent Application Publication
(10) Pub. No.: US 2012/0102277 A1
(43) Pub. Date: Apr. 26, 2012

(54) DATA STORAGE DEVICE AND WRITE METHOD THEREOF

(75) Inventors: Jin Kyu Kim, Seoul (KR); Wonmoon Cheon, Hwaseong-si (KR); Sung Hoon Baek, Daejeon (KR)

(73) Assignee: Samsung Electronics Co., Ltd, Suwon-si (KR)

(21) Appl. No.: 13/165,074

(22) Filed: Jun. 21, 2011

(30) Foreign Application Priority Data
Jun. 21, 2010 (KR) 10-2010-0058751

(51) Int. Cl. G06F 12/00

(52) U.S. Cl. 711/154; 711/E12.001

(57) ABSTRACT

A write method of a data storage device including a storage media includes compressing data to be stored in the storage media; determining compressed data start positions of a physical unit of the storage media in which the compressed data is to be stored; and storing the compressed data from the determined compressed data start positions of the physical unit, respectively.

### CROSS-REFERENCE TO RELATED APPLICATIONS

This application claims the benefits, under 35 U.S.C. §119, of Korean Patent Application No. 10-2010-0058751 filed on Jun. 21, 2010, the entirety of which is incorporated by reference herein.

### BACKGROUND OF THE INVENTION

1. Field of the Invention

Exemplary embodiments relate to electronic devices, and more particularly, relate to a data storage device and a method thereof.

2. Description of the Related Art

Computer systems generally use several types of memory systems. For example, the memory systems may be a main memory including semiconductor devices typically having attributes that data can be randomly written to and read from with comparable and very fast access times and thus the semiconductor devices are commonly referred to as random access memories. However, since semiconductor memories are relatively expensive, other higher density and lower cost memories are often used. For example, other memory systems include magnetic disk storage systems. In a case of the magnetic disk storage systems, generally, access times may be tens of milliseconds. On the other hand, in a case of the main memory, the access times may be hundreds of nanoseconds. Disk storage is used to store large quantities of data which can be sequentially read into main memory as needed. Another type of disk like storage is solid state disk storage (SSD, also called solid state drive). The SSD is a data storage device that uses memory chips, such as SDRAM, to store data, instead of using spinning platters or disks mounted in conventional hard disk drives.

The term “SSD” is used for two different kinds of products. As the first type of SSD, based on an access speed or operation speed in writing or reading, a volatile memory, such as SDRAM, is categorized by extremely fast data access and is used primarily to accelerate applications that are held back by the latency of disk drives. Since this SSD uses the volatile memory, it typically incorporates internal battery and backup disk systems to ensure data persistence. If power is lost for whatever reason, the battery keeps the unit or system powered long enough to copy all data from a RAM to a backup disk. Upon the restoration of power, data is copied back from the backup disk to the RAM and the SSD resumes a normal operation. The first type of SSD is especially useful on a computer which already has the maximum storage amount of the RAM. The second type of SSD uses a flash memory to store data and is generally used to replacement of a hard disk drive.

### SUMMARY OF THE INVENTION

The present general inventive concept provides an electronic system, a data storage device, and a method of operating the same to compress data to be stored in a storage unit according to characteristics of the data, a logical unit of the data, or a physical unit of the storage unit.

Additional aspects and advantages of the present general inventive concept will be set forth in part in the description which follows and, in part, will be obvious from the description, or may be learned by practice of the general inventive concept.

The features and utilities of embodiments of the inventive concept is directed to provide a write method of a data storage device including a storage media. The write method includes compressing data to be stored in the storage media, determining compressed data start positions of a physical unit of the storage media in which the compressed data is to be stored, and storing the compressed data from the determined compressed data start positions of the physical unit, respectively.

The features and utilities of embodiments of the inventive concept is directed to provide a data storage device which comprises a storage media; and a controller configured to compress data to be stored in the storage media, wherein the controller compresses data to be stored in the storage media so that a size of the compressed data is fitted to a size of a physical unit of the storage media.

The features and utilities of embodiments of the inventive concept is directed to provide a data storage device which comprises a storage media; and a controller configured to compress data to be stored in the storage media, wherein the controller determines compressed data start positions of a physical unit of the storage media in which the compressed data is to be stored, and controls the storage media so as to store the compressed data from the determined compressed data start positions of the physical unit, respectively.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a data storage device according to an exemplary embodiment of the inventive concept.

FIG. 2 is a block diagram illustrating a controller illustrated in FIG. 1 according to an exemplary embodiment of the inventive concept.

FIG. 3 is a block diagram illustrating a storage media illustrated in FIG. 1 according to an exemplary embodiment of the inventive concept.

FIG. 4 is a diagram illustrating an exemplary mapping table managed by a flash translation layer (FTL).

FIG. 5 is a diagram illustrating a physical unit described in FIG. 4.

FIG. 6 is a diagram illustrating a write operation of a storage media according to an exemplary embodiment of the inventive concept.

FIG. 7 is a diagram illustrating compressed data stored in each physical unit PU at a write operation of a data storage device according to an exemplary embodiment of the inventive concept.

FIG. 8 is a diagram illustrating a write operation of a storage media according to another exemplary embodiment of the inventive concept.

FIG. 9 is a diagram illustrating a write operation of a storage media according to still another exemplary embodiment of the inventive concept.

FIG. 10 is a diagram illustrating a mapping table according to a write operation of a data storage device described in FIG. 9.

FIG. 11 is a diagram illustrating compressed data stored in each physical unit PU at a write operation of a data storage device described in FIG. 9.

FIGS. 12 and 13 are diagrams illustrating a write operation of a storage media according to still other exemplary embodiments of the inventive concept.

FIG. 14 is a diagram illustrating a mapping table according to a write operation of a data storage device described in FIG. 13.

FIG. 15 is a block diagram illustrating a storage using a Solid State Drive (SSD) as a data storage device according to an exemplary embodiment of the inventive concept.

FIG. 16 is a block diagram illustrating a storage server using the SSD illustrated in FIG. 15.

FIG. 17 is a block diagram illustrating a storage according to another exemplary embodiment of the inventive concept.

FIG. 18 is a block diagram illustrating a storage server using a storage illustrated in FIG. 17.

FIGS. 19 to 21 are diagrams illustrating systems to which a data storage device according to exemplary embodiments of the inventive concept is applied.

FIGS. 22 and 23 are flowcharts illustrating a method of a data storage system.

### DETAILED DESCRIPTION OF THE PREFERRED EMBODIMENTS

The inventive concept is described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

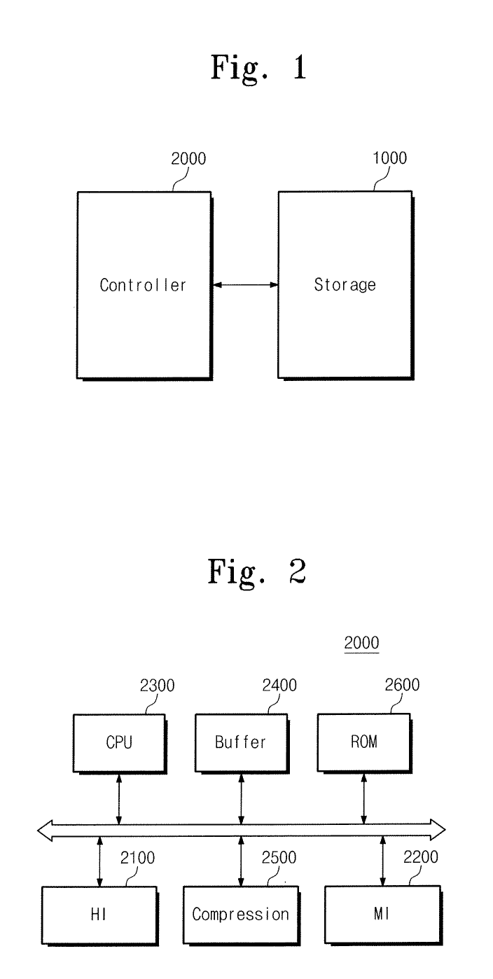

FIG. 1 is a block diagram illustrating a data storage device (or data storage system) according to an exemplary embodiment of the inventive concept.

Referring to FIG. 1, the data storage system includes a storage media (or storage unit) 1000 and a controller 2000. The storage media 1000 may be used to store data information having various types such as texts, graphics, software codes, and the like. The storage media (or storage unit) 1000 may include a non-volatile memory such as PRAM, FeRAM, MRAM, or the like. But, it is well understood that non-volatile memories applied to the storage media 1000 are not limited thereto.

The controller 2000 is configured to control the storage media 1000 in response to external requests transmitted from at least one external device. The controller 2000 is configured to compress data received from the external device using at least one of data compressing methods (manners) and to store the compressed data in the storage media 1000. Since the data compressing methods are well known, detail descriptions thereof will be omitted. The data compressing manner enables the storage media 1000 to be used effectively. For example, the storage media 1000 stores a larger amount of data to be compressed by using the data compressing manner than an amount of data without using the data compressing manner. Further, with the data compressing manner, it is possible to reduce the amount of data transferred between the storage media 1000 and the controller 2000. That is, with the data compressing manner, there is reduced a transfer time taken to transfer data between the storage media 1000 and the controller 2000.

The storage unit 1000 and the controller 2000 may be formed in a single body of the data storage system. In this case, the storage unit 1000 and the controller 2000 may be connected through internal signal lines. However, it is possible that the storage unit 1000 and the controller 2000 may be formed in different bodies of the data storage system. In this case, the storage unit 1000 and the controller 2000 may communicate with each other using a wired or wireless communication structure and method.

FIG. 2 is a block diagram illustrating the controller 2000 of FIG. 1 according to an exemplary embodiment of the inventive concept.

Referring to FIG. 2, the controller 2000 may include a first interface 2100, a second interface 2200, a CPU 2300 as a processing unit, a buffer 2400, a compression block (or compressing unit) 2500, and a ROM 2600.

The first interface 2100 is configured to interface with an external device (or, a host). The second interface 2200 is configured to interface with the storage media 1000 illustrated in FIG. 1. As a processing unit, the CPU 2300 is configured to control an overall operation of the controller 2000. For example, the CPU 2300 is configured to execute firmware such as a flash translation layer (FTL) stored in the ROM 2600. As will be described, the FTL may be used to manage mapping information on memory spaces of the storage media 1000 to store data. But, the FTL is not limited thereto. For example, the FTL may include information which can be used to manage wear-leveling, bad blocks, data retention caused due to unexpected power interruption, and the like.

The buffer 2400 is used to temporarily store data transferred from an external device via the first interface 2100. The buffer 2400 is used to temporarily store data transferred from the storage media 1000 via the second interface 2200. The compression block 2500 operates according to the control of the CPU 2300 (or, the control of the FTL executed by the CPU 2300) and is configured to compress data stored in the buffer 2400. And then the compressed data is transmitted to and stored in the storage media 1000 via the second interface 2500. The compression block 2500 operates according to the control of the CPU 2300 (or, the control of the FTL executed by the CPU 2300) and is configured to decompress data (or release compressed data) read out from the storage media 1000.

In an exemplary embodiment, a compression function of the compression block 2500 may be made optionally/selectively according to characteristics of the received data, characteristics of a storage space, a relationship between the received data and the storage space, and/or a characteristic of the storage media 1000. In this case, input data is stored in the storage media 1000 via the buffer 2400 without data compression. For example, ON/OFF of the compression block 2500 may be made according to received data. If multimedia data which has been already compressed as compressed data is provided to a data storage device or if energy is relatively much consumed at data compression due to a remarkably small size of data, the compression block 2500 may be set to an OFF state. The ON/OFF of the compression block 2500 may be made by hardware (for example, register) or software setting. Unlike the above description, externally provided data is able to be stored directly in the storage media 1000 via the first and second interfaces 2100 and 2200.

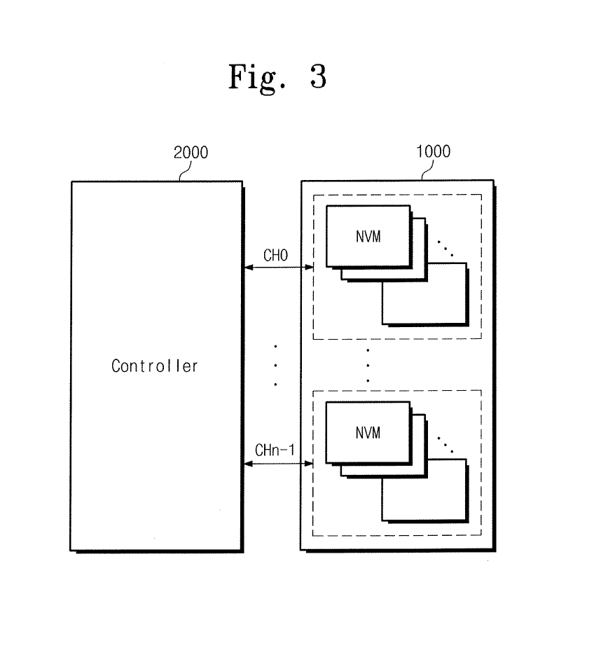

FIG. 3 is a block diagram illustrating the controller of FIG. 1 according to an exemplary embodiment of the inventive concept.

Referring to FIG. 3, the storage media 1000 operates according to the control of the controller 2000. The storage media 1000 is connected with the controller 2000 through a plurality of channels CH0˜CHn−1, each of which is commonly connected with a plurality of non-volatile memories NVM. The controller 2000 is configured to compress data received from an external device and to release compressed data (or, decompress data) read from the storage media 1000. One non-volatile memory NVM is selected by channel and chip number information. The channel and chip number information can be determined to designate one of non-volatile memories NVM or one of memories of each non-volatile memory NVM according to, for example, characteristics of the received data, characteristics of a storage space, a relationship between the received data and the storage space, a characteristic of the storage media 1000, and/or information (or chip number) on the storage media 1000. If a “way” is additionally applied to the storage media 1000, one non-volatile memory NVM is selected by channel, way, and chip number information. The “way” may be used to designate one of a plurality of memory units (planes or rows, for example) of the non-volatile memory NVM which can correspond to a single channel if the non-volatile memory NVM is formed with a plurality of memory units.

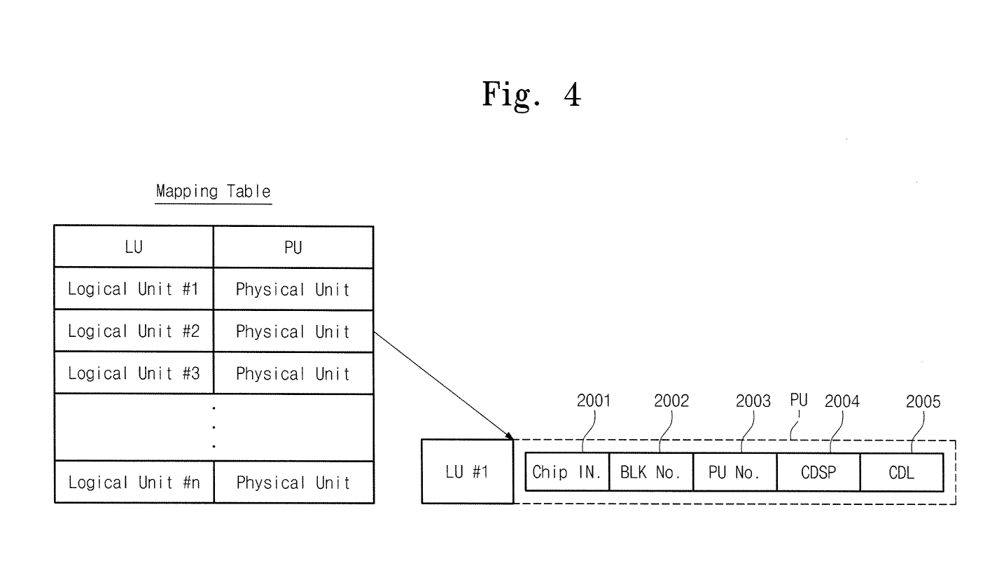

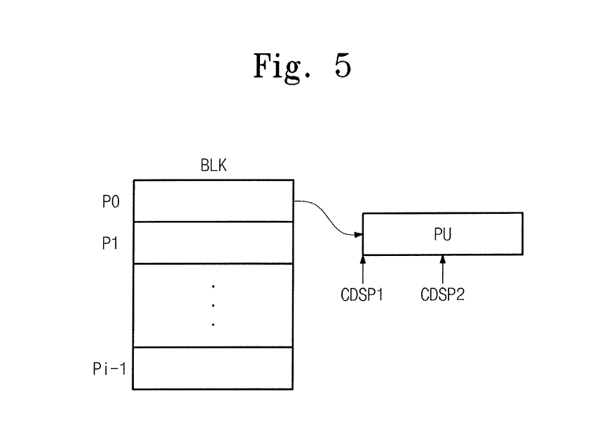

FIG. 4 is a diagram illustrating an exemplary mapping table managed by a flash translation layer (FTL), and FIG. 5 is a diagram illustrating a physical unit described in FIG. 4.

Referring to FIG. 4, a data storage device according to an exemplary embodiment of the inventive concept is configured to manage a correspondence (or relationship) between a logical unit LU and a physical unit PU using a flash translation layer FTL. In an exemplary embodiment, a size of a logical unit LU is set to be identical to that of a physical unit PU of a storage media 1000. However, it is well understood that a size of a logical unit LU is set to be less than or more than that of a physical unit PU of the storage media 1000. That is, a size (data amount) of a logical unit LU may be different from a size (data storing space) of a physical unit PU. Externally provided data is configured to a logical unit LU by the data storage device. A physical unit of the storage media 1000 can be set to a word unit, a page unit, a sector unit, a block unit, a super-block unit, or the like based on a non-volatile memory applied to the storage media 1000. A physical unit PU of the storage media 1000 may be set to one page. Herein, if a non-volatile memory has an M-plane array structure (M being 2 or more integer), a super-block is formed of M memory blocks which belong to respective M planes and the same row.

The correspondence between a logical unit LU and a physical unit PU is managed by a mapping table (or mapping information). In accordance with an exemplary embodiment of the inventive concept, for example, one or more logical units are mapped to one physical unit PU through a compression process. Information necessary to appoint (designate) a physical unit PU, as illustrated in FIG. 4, may include chip information 2001, block information 2002, physical unit information 2003, compressed data start position (CDSP) information 2004, and compressed data length (CDL) information 2005. The chip information 2001 may include channel, way, and chip number information. The block information 2002 includes a memory block number (for example, number indicating one of M memory blocks), and the physical unit information 2003 includes a page number. The compressed data start position information 2004 includes one of compressed data start positions of a physical unit PU. Each of compressed data start positions of a physical unit PU indicates the position where compressed data starts to be stored.

As illustrated in FIG. 5, a plurality of, for example, two compressed data start positions CDSP1 and CDSP2 are assigned to one physical unit PU. FIG. 5 illustrates one example that two compressed data start positions CDSP1 and CDSP2 are assigned to one physical unit PU. However, the present general inventive concept is not limited thereto. For example, three or more compressed data start positions can be assigned to one physical unit PU. The number of compressed data start positions assigned to one physical unit PU may be determined according to applications to which a data storage device is applied. Intervals between compressed data start positions in each physical unit are set uniformly. Alternatively, it is possible that the intervals between compressed data start positions in each physical unit can be set irregularly, variably, or randomly according to the mapping table or a determination thereof. In other words, one physical unit is formed of two or more segments based on the number of compressed data start positions, and segments in one physical unit may have identical to or different from one another, based on intervals between compressed data start positions.

Compressed data of one or more logical units may be stored in one physical unit PU based on a size of compressed data. Compressed data corresponding to a logical unit starts to be stored from a compressed data start position of an assigned physical unit PU. If a size of a compressed data is more than that corresponding to an interval between compressed data start positions, that is, a size of a PU segment, the compressed data corresponding to a logical unit LU may be stored through two or more compressed data start positions. Compressed data corresponding to a next logical unit LU starts to be stored from a new compressed data start position of the assigned physical unit PU. This will be more fully described below.

For example, a data block BLK of the storage media 1000 is assigned to store data of a plurality of logical units P0, P1, . . . Pi−1, according to the mapping information. In FIG. 5, when the number of logical units is 2, “i” is 2, and then data of the logical units P0 and P1 is compressed and/or stored in the physical unit PU of the data block BLK of the storage medial. That is, the logical unit P0 may be stored from a compressed data start position CDSP1 of the physical unit PU, and data of the logical unit P1 may be stored from a compressed data start position CDSP2 of the physical unit PU.

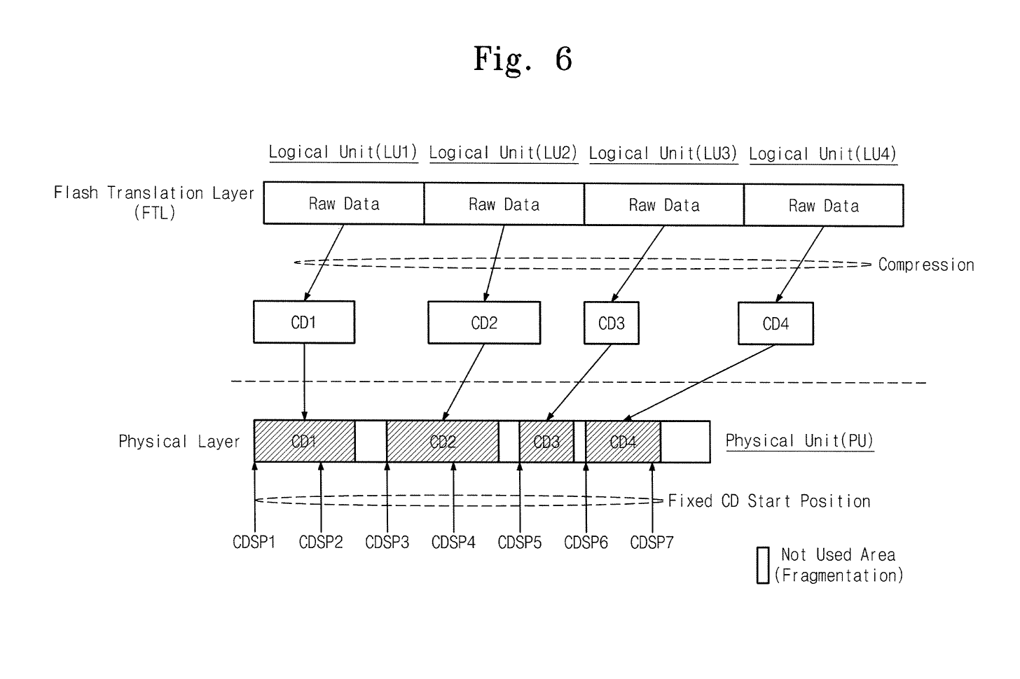

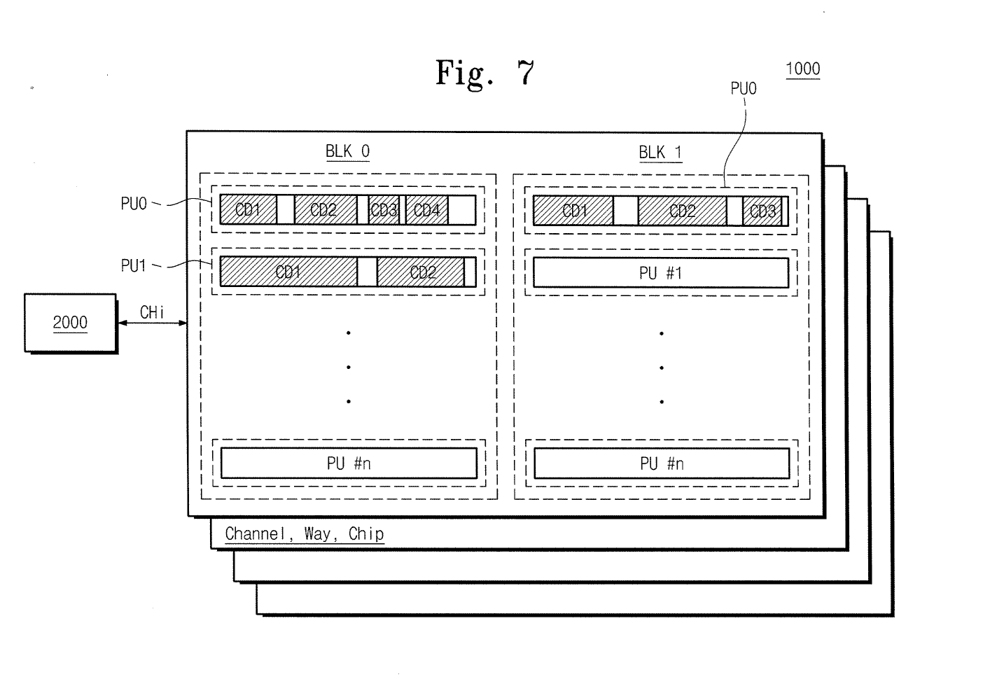

FIG. 6 is a diagram illustrating a write operation of a storage media according to an exemplary embodiment of the inventive concept. A write operation of a storage media according to an exemplary embodiment of the inventive concept will be more fully described with reference to accompanying drawings.

Once a write operation commences, raw/uncompressed data may be continuously provided to a data storage device from an external device. Received data is compressed by a compression block 2500 of the data storage device, and compressed data is stored in a storage media 1000. More detailed description is as follows.

Raw/uncompressed data continuously provided to a data storage device (data storage system) is temporarily stored in a buffer 2400. Data stored in the buffer 2400 may be data provided according to one or more host write requests from a host connected to the data storage device or from another unit of a host installed with the data storage device. A compression block 2500 may compress data stored in the buffer 2400 on the basis of a logical unit LU. For ease of description, uncompressed data of four logical units LU1 to LU4 is illustrated in FIG. 6.

Uncompressed data of a logical unit LU1 is compressed by the compression block 2500, and a flash translation layer FTL manages a mapping table having a correspondence between the logical unit LU1 and a physical unit PU. One mapping table entry includes mapping information between a logical unit LU and a physical unit PU. As described above, the position where data corresponding to the logical unit LU1 is stored is determined by the mapping information. The mapping information between the logical unit LU1 and a physical unit PU includes chip information 2001, block information 2002, physical unit information 2003, compressed data start position (CDSP) information 2004, and compressed data length (CDL) information 2005. For example, as illustrated in FIG. 6, compressed data CD1 starts to be stored from a compressed data start position CDSP1 of a physical unit PU. The compressed data length information 2005 indicative of a size of the compressed data CD1 is used to detect an end of the compressed data CD1, upon a read request of the compressed data CD1. Based on mapping information, a controller 2000 provides the storage media 1000 with address information of a physical area, in which the compressed data CD1 is to be stored, together with the compressed data CD1. Since a size of the compressed data CD1 is more than a size of one PU segment, two PU segments are assigned to the compressed data CD1. For example, the compressed data CD1 of the logical unit LU1 is stored from the compressed data start position CDSP1 through the compressed data start position CDSP2. Since two PU segments are assigned to the compressed data CD1, a compressed data start position CDSP3 is assigned to compressed data to be stored a next logical unit LU2.

After compressing and storing of the logical unit LU1 or before compressing and storing of the logical unit LU1 are ended, uncompressed data of a logical unit LU2 is compressed by the compression block 2500, and the FTL manages the mapping table having a correspondence between the logical unit LU2 and a physical unit PU. Since the compressed data CD1 is stored within two PU segments, as illustrated in FIG. 6, compressed data CD2 starts to be stored from a compressed data start position CDSP3 of a physical unit PU. Based on mapping information, the controller 2000 provides the storage media 1000 with address information of a physical area, in which the compressed data CD2 is to be stored, together with the compressed data CD2. Since a size of the compressed data CD2 is more than a size of one PU segment, two PU segments are assigned to the compressed data CD2. Since two PU segments are assigned to the compressed data CD2, a compressed data start position CDSP5 is assigned to compressed data to be stored next.

Compressing and storing of the remaining logical units LU3 and LU4 are made the same as described above, and description thereof is thus omitted.

As illustrated in FIG. 6, the compressed data CD1, CD2, CD3, and CD4 of the corresponding four logical units LU1, LU2, LU3, and LU4 are stored through the segments of the physical unit PU, and the stored compressed data CD1, CD2, CD3, and CD4 are separated by corresponding fragmentations which are not used areas to store the compressed data CD1, CD2, CD3, and CD4. The fragmentations may be same in size, but it is possible that the sizes of the fragmentations may be different from one another depending on a size of the compressed data.

It is possible that the compression block 2500 may compress the data with the same compression ratio. However, it is also possible that the compression ratios between data of the logical data and the compressed data may be different from each other. The compression ratio may be determined by the controller 2000 according to a predetermined setting, a user input, or characteristics of the data to be stored in the storage media 1000.

FIG. 7 is a diagram illustrating compressed data stored in each physical unit PU at a write operation of a data storage device according to an exemplary embodiment of the inventive concept.

Referring to FIG. 7, compressed data of two or more logical units may be stored in one physical unit PU, based on a size of the compressed data. Compressed data stored in each physical unit may be read according to the above-described mapping information, that is, chip information 2001, block information 2002, physical unit information 2003, compressed data start position (CDSP) information 2004, and compressed data length (CDL) information 2005. For example, compressed data CD2 stored in a physical unit PU0 of a memory block BLK0 may be read out by providing chip, block, and physical unit information to a storage media 1000, performing a read operation to the physical unit PU0, and fetching compressed data CD2 of data read from the physical unit PU0 based on compressed data start position information and compressed data length information.

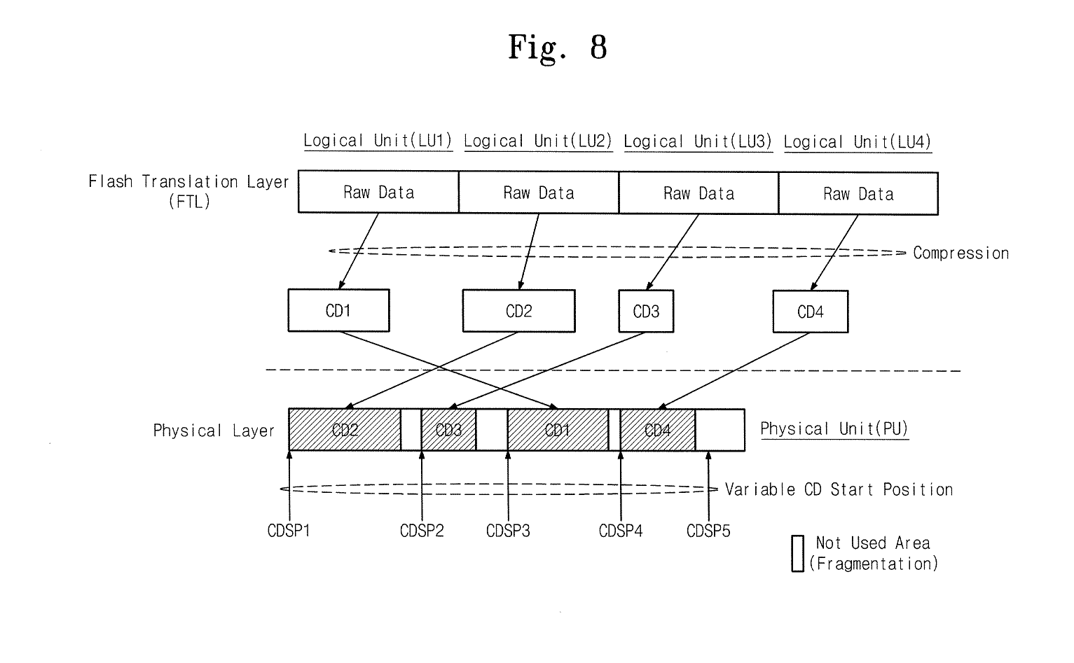

FIG. 8 is a diagram illustrating a write operation of a storage media according to another exemplary embodiment of the inventive concept. Below, a write operation of a storage media according to another exemplary embodiment of the inventive concept will be more fully described with reference to accompanying drawings.

A write manner of a data storage device illustrated in FIG. 8 is identical to that illustrated in FIG. 6 except the following differences, and description thereof is thus omitted. Compression of raw data corresponding to a logical unit LU may executed in a same compression method or ratio, while a compressed data start position is determined randomly according to a size of compressed data. For example, intervals between compressed data start positions are set irregularly or variably. A compressed data start position is determined according to a size of compressed data. For example, as illustrated in FIG. 8, CDPS information of compressed data CD1 is assigned to be stored from CDSP3, CDPS information of compressed data CD2 is assigned to be stored from CDSP1, CDPS information of compressed data CD3 is assigned to be stored from CDSP2, and CDPS information of compressed data CD4 is assigned to be stored from CDSP4. CDPS information assigned to each of compressed data CD1 to CD4 in one physical unit PU is managed through a mapping table. Compressed data stored in each physical unit PU is read in the same manner as illustrated in FIG. 7, and description thereof is thus omitted.

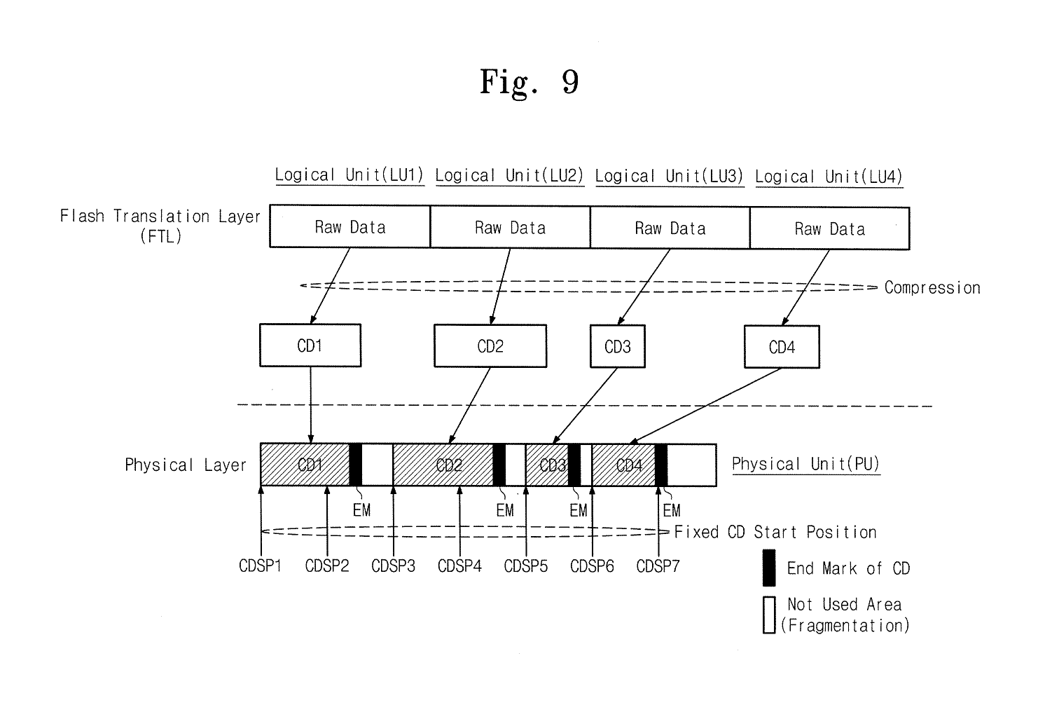

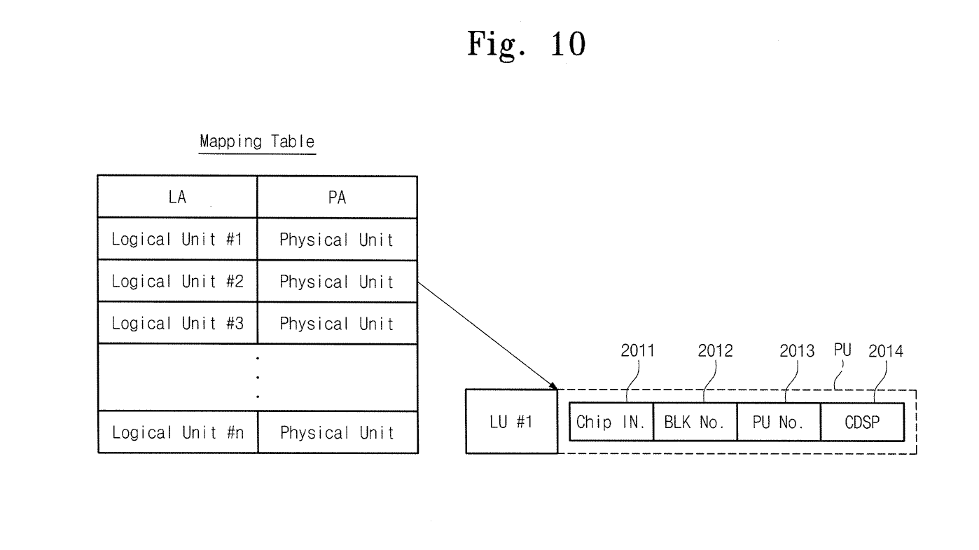

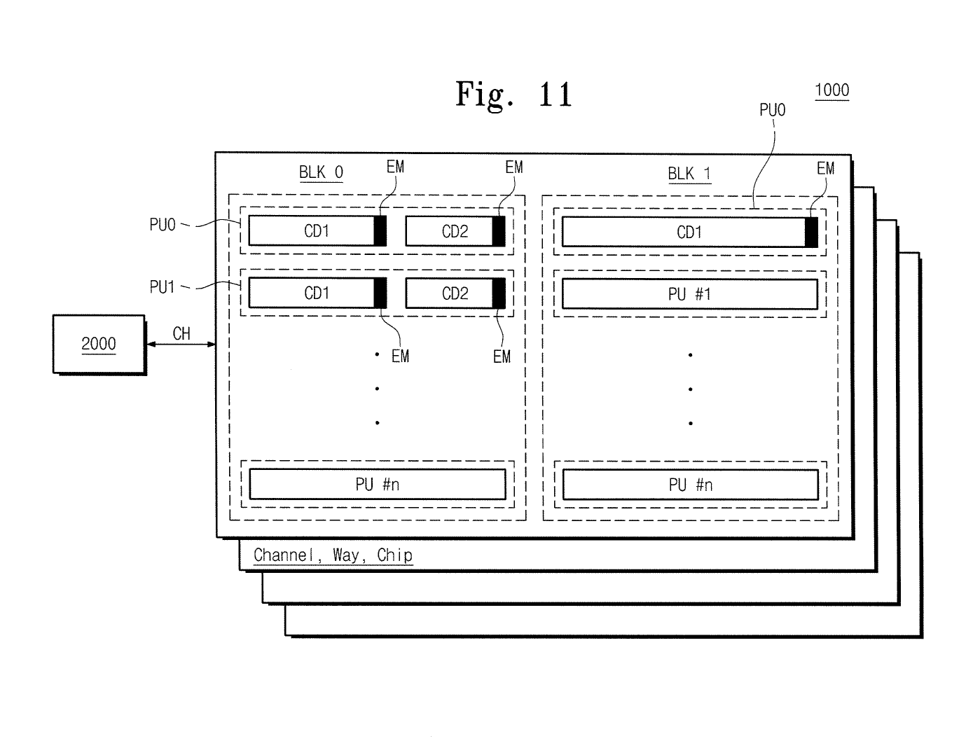

FIG. 9 is a diagram illustrating a write operation of a storage media according to still another exemplary embodiment of the inventive concept, and FIG. 10 is a diagram illustrating a mapping table according to a write operation of a data storage device described in FIG. 9. Below, a write operation of a storage media according to still another exemplary embodiment of the inventive concept will be more fully described with reference to accompanying drawings.

A write manner illustrated in FIG. 9 is identical to that described in FIG. 6 except the following differences, and description thereof is thus omitted. With the write manner of a data storage device illustrated in FIG. 9, an end mark EM indicative of an end of compressed data is added to each compressed data. The end mark EM is formed of a bit string of a pattern which is not included in compressed data. For example, the end mark EM may be generated using the Huffman algorithm so as to be formed of a bit string of a pattern not included in compressed data. It is unnecessary to store mapping information indicative of a size of compressed data in a mapping table (or, each mapping table entry) by adding an end mark EM to the compressed data. As described above, a correspondence (relationship) between a logical unit LU and a physical unit PU is managed through a mapping table. Information needed to appoint a physical unit PU, as illustrated in FIG. 10, comprises chip information 2011, block information 2012, physical unit information 2013, and compressed data start position (CDSP) information 2014. As an end mark EM is added to compressed data, it is possible to judge an end of compressed data without compressed data length information at a read operation.

FIG. 11 is a diagram illustrating compressed data stored in each physical unit PU at a write operation of a data storage device described in FIG. 9.

Referring to FIG. 11, compressed data of two or more logical units may be stored in one physical unit PU, based on a size of compressed data. Compressed data in each physical unit PU is read according to the above-described mapping information, that is, chip information 2011, block information 2012, physical unit information 2013, and compressed data start position (CDSP) information 2014. For example, compressed data CD2 stored in a physical unit PU0 of a memory block BLK0 may be read out by providing chip, block, and physical unit information to a storage media 1000, performing a read operation to the physical unit PU0, and fetching data read from the physical unit PU0 based on compressed data start position information until an end mark EM of compressed data is detected. Reading of compressed data is terminated when the end mark EM is detected.

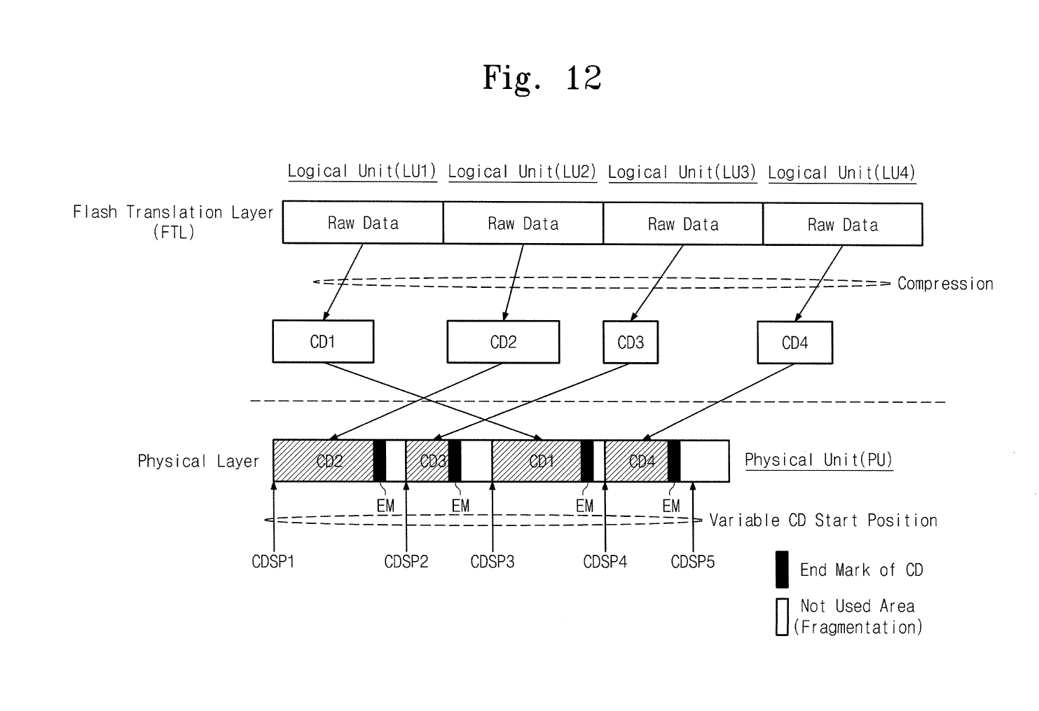

FIG. 12 is a diagram illustrating a write operation of a storage media according to still another exemplary embodiment of the inventive concept.

A write manner illustrated in FIG. 12 is identical to that described in FIG. 9 except compressed data start positions which can be set randomly or variably, and description thereof is thus omitted. That is, as illustrated in FIG. 12, intervals between compressed data start positions CDSP1 to CDSP5 are set irregularly or variably.

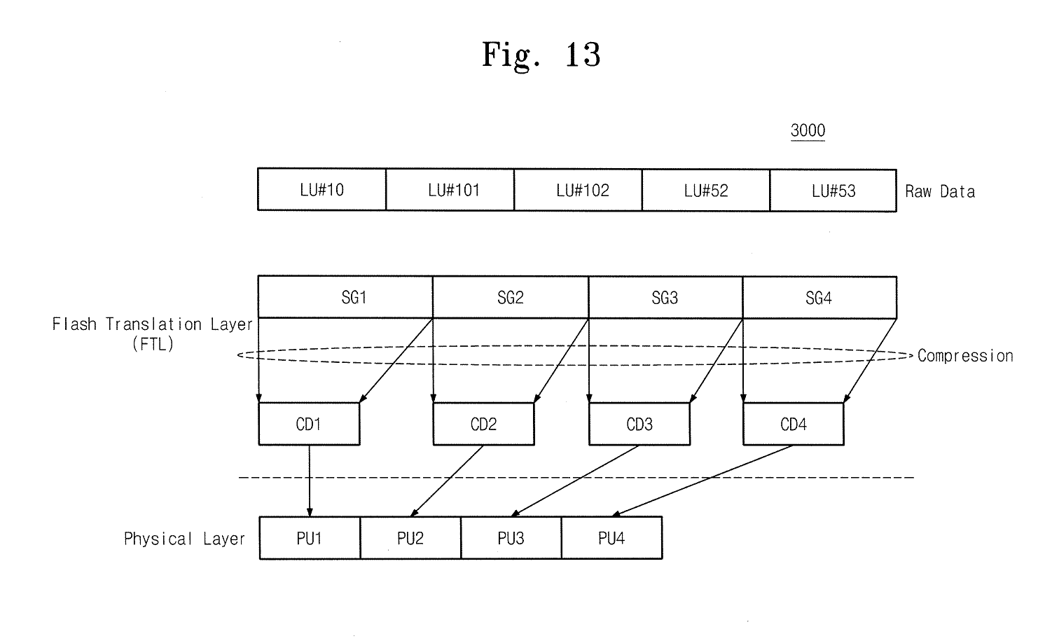

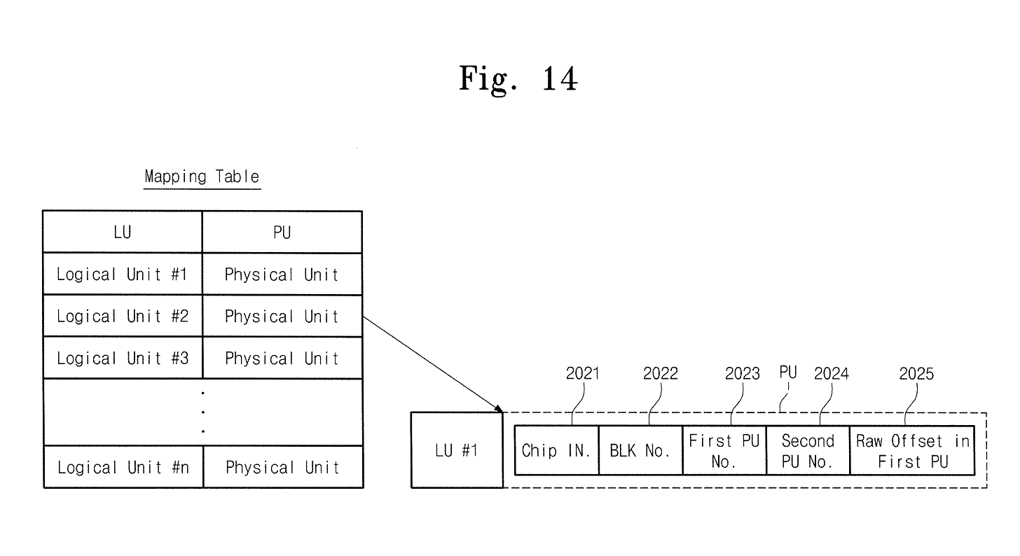

FIG. 13 is a diagram illustrating a write operation of a storage media according to still another exemplary embodiment of the inventive concept, and FIG. 14 is a diagram illustrating a mapping table according to a write operation of a data storage device illustrating in FIG. 13. Below, a write operation of a storage media according to still another exemplary embodiment of the inventive concept will be more fully described with reference to accompanying drawings.

Data to be stored in a storage media according to a write request of a host is stored in a buffer of a controller 3000. In FIG. 13, there is illustrated an example that data corresponding to five logical units LU#10, LU#101, LU#102, LU#52, and LU#53 is stored in the buffer of the controller 3000. Data in the buffer of the controller 3000 may correspond to one or more host write requests.

With the assumption that a size of a logical unit LU is identical to that of a physical unit PU, compressed data of a logical unit LU is less in size than a physical unit PU. For this reason, referring back to FIG. 6, a physical unit includes an unused area (or, fragmentation). The fragmentation of the physical unit PU may be minimized by compressing raw/uncompressed data such that a size of compressed data is fitted to a size of a physical unit. With this compression manner, data of a logical unit LU may be recovered by releasing compression (uncompressing) of data stored in two physical units. For example, referring to FIG. 13, data of a logical unit LU#10 is recovered by releasing compressed data CD1 of a physical unit PU1. Data of a logical unit LU#101 is recovered by releasing (uncompressing) compressed data of two physical units PU1 and PU2.

The position where data of a logical unit is stored may be stored in a mapping table. Raw data of a logical unit, as illustrated in FIG. 14, is read based on chip information 2021, block information 2022, position information of the first physical unit 2023, position information of the second physical unit 2024, and offset information of the first physical unit 2025. For example, compressed data CD1 is generated by data of a logical unit LU#10 and a part of data of a logical unit LU#101, and compressed data CD2 is generated by the remaining data of the logical unit LU#101 and a part of data of a logical unit LU#102. In this case, data of the logical unit LU#10 and a part of data of the logical unit LU#101 are stored in a physical unit PU1, and the remaining data of the logical unit LU#101 and a part of data of the logical unit LU#102 are stored in a physical unit PU2.

Data of the logical unit LU#10 is recovered by releasing compressed data CD1 of the physical unit PU1. On the other hand, data of the logical unit LU#101 is recovered by releasing compressed data CD1 and CD2 of physical units PU1 and PU2. Start position of data of the logical unit LU#101 included in the compressed data CD1 is judged according to offset information 2025 of the first physical unit PU1 stored in the mapping table. Likewise, data of the logical unit LU#102 is recovered by releasing compressed data CD2 and CD3 of physical units PU2 and PU3. Start position of data of the logical unit LU#101 included in the compressed data CD2 is determined according to offset information 2025 of the first physical unit PU2 stored in the mapping table.

With the above description, it is possible to minimize the fragmentation of a physical unit PU by compressing raw/uncompressed data such that a size of compressed data is fitted to that of a physical unit.

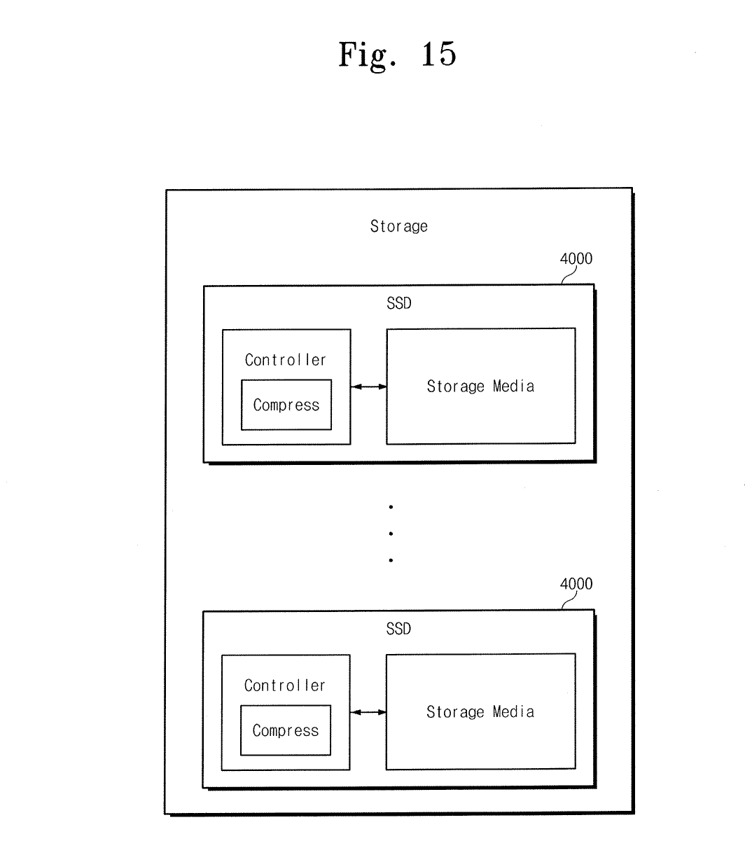

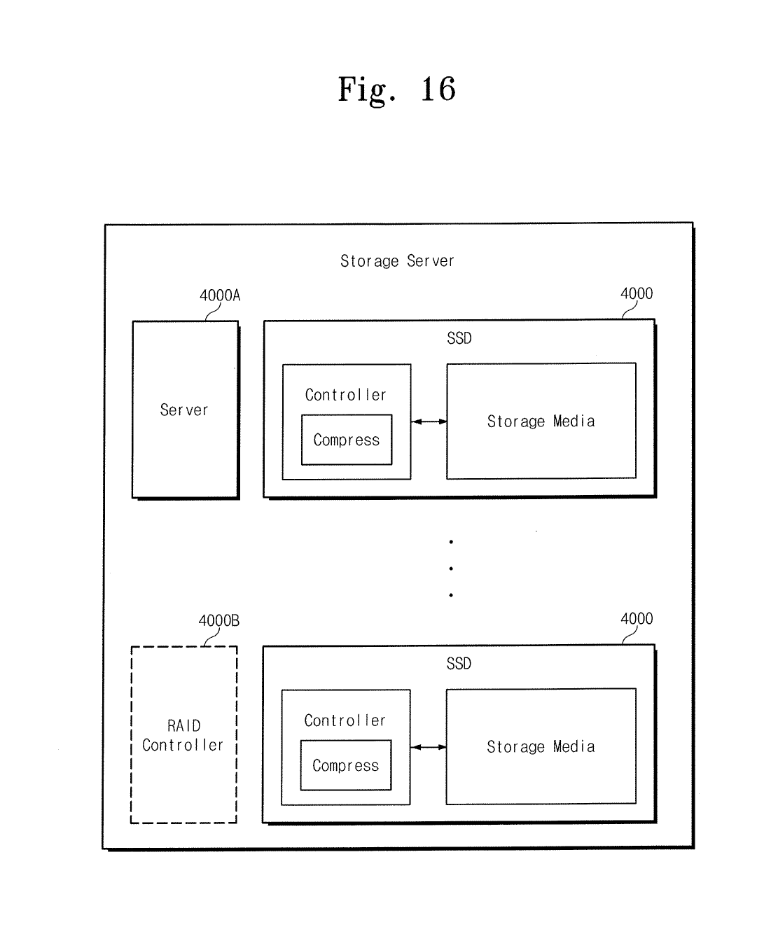

A data storage device according to an exemplary embodiment of the inventive concept may be a solid state drive SSD. A block diagram showing a storage using a Solid State Drive (SSD) as a data storage device is illustrated in FIG. 15, and a block diagram showing a storage server using SSD illustrated in FIG. 15 is illustrated in FIG. 16.

An SSD 4000 according to an exemplary embodiment of the inventive concept can be used as a storage. As illustrated in FIG. 15, a storage includes a plurality of solid state drives 4000 which are configured the same as described in FIG. 3. The SSD 4000 according to an exemplary embodiment of the inventive concept can be used as a storage sever. As illustrated in FIG. 16, a storage server includes a plurality of solid state drives 4000, which are configured the same as described in FIG. 15, and a server 4000A. Further, it is well comprehended that a well-known RAID controller 4000B is provided in the storage server.

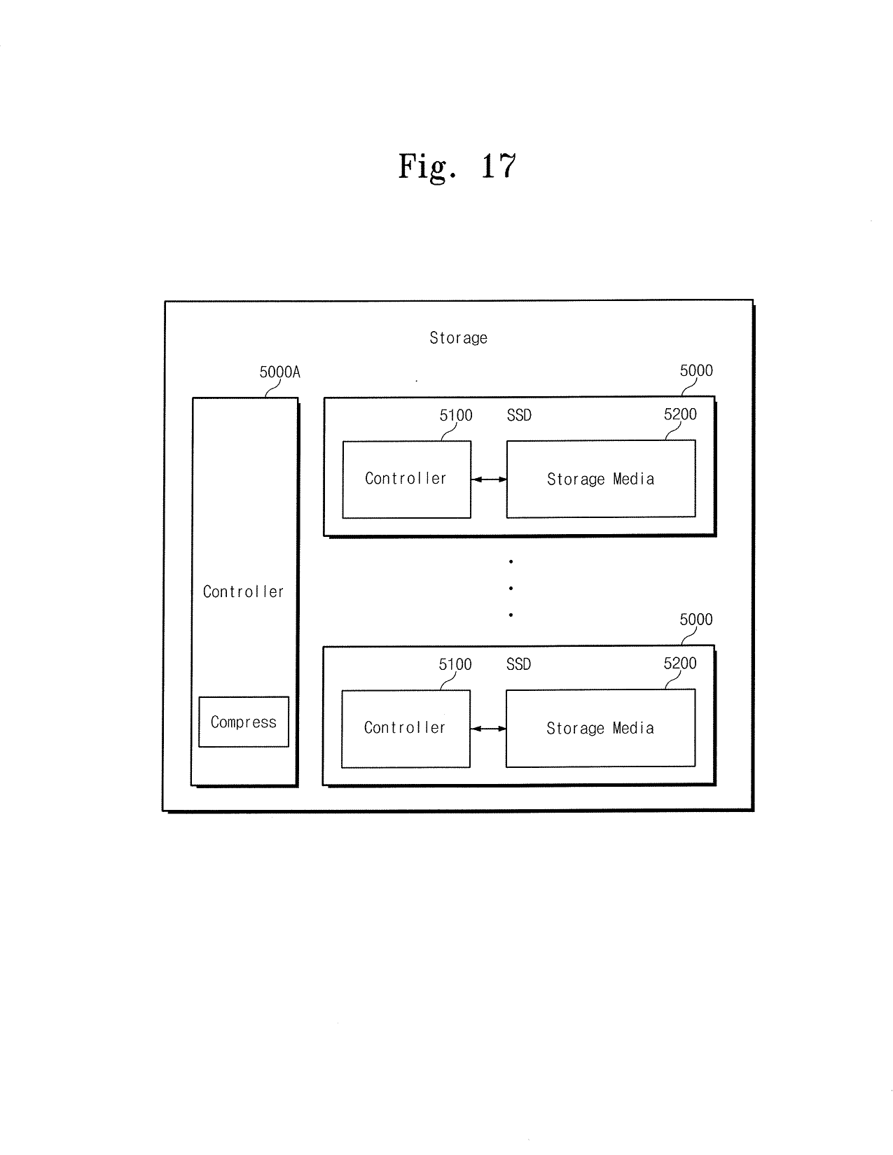

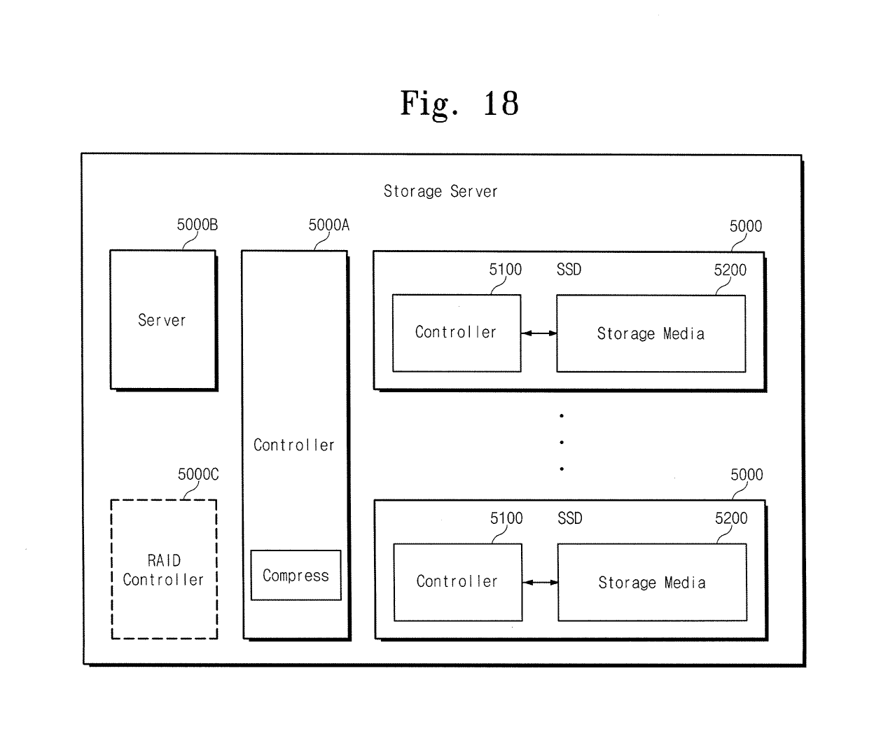

FIG. 17 is a block diagram illustrating a storage according to another exemplary embodiment of the inventive concept, and FIG. 18 is a block diagram illustrating a storage server using a storage illustrated in FIG. 17.

Referring to FIG. 17, a storage may include a plurality of solid state drives 5000 and a control block 5000A. Each of the solid state drives 5000 includes a controller 5100 and a storage media 5200. The controller 5100 is configured to perform an interface function with the storage media 5200. The solid state drives 5000 are controlled by the control block 5000A. The control block 5000A is configured to perform the above-described functions. The storage illustrated in FIG. 17 can be used as a storage server. As illustrated in FIG. 18, a storage server includes a server 5000B and a storage (5000, 5000A) which is configured to be identical to that in FIG. 17. Further, it is well comprehended that a well-known RAID controller 5000C is provided in the storage server.

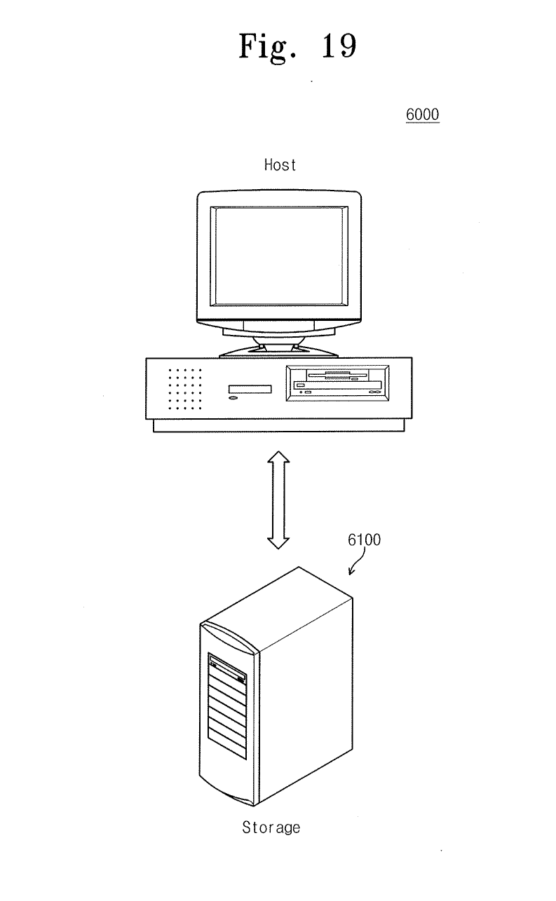

FIGS. 19 to 21 are diagrams illustrating systems to which a data storage device according to exemplary embodiments of the inventive concept is applied.

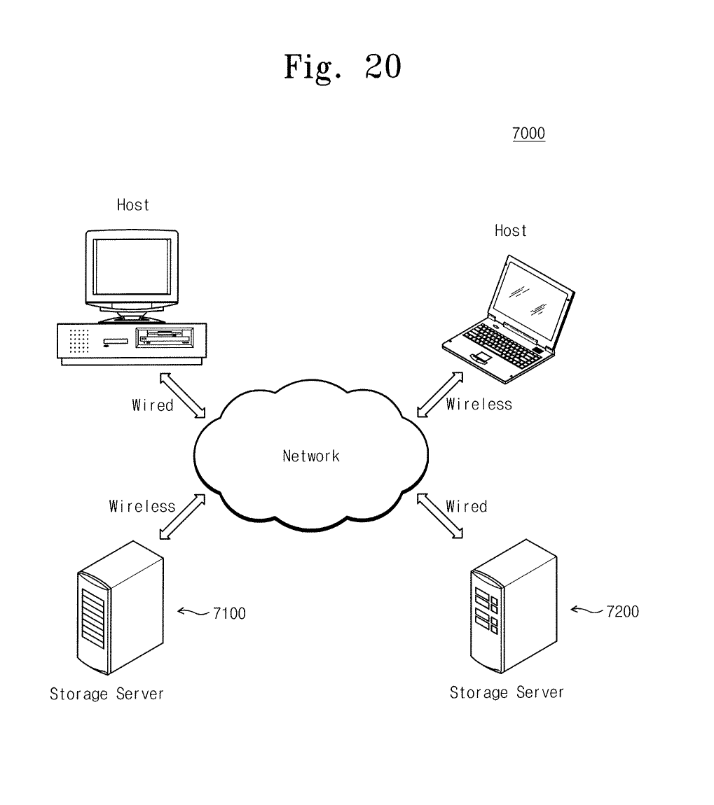

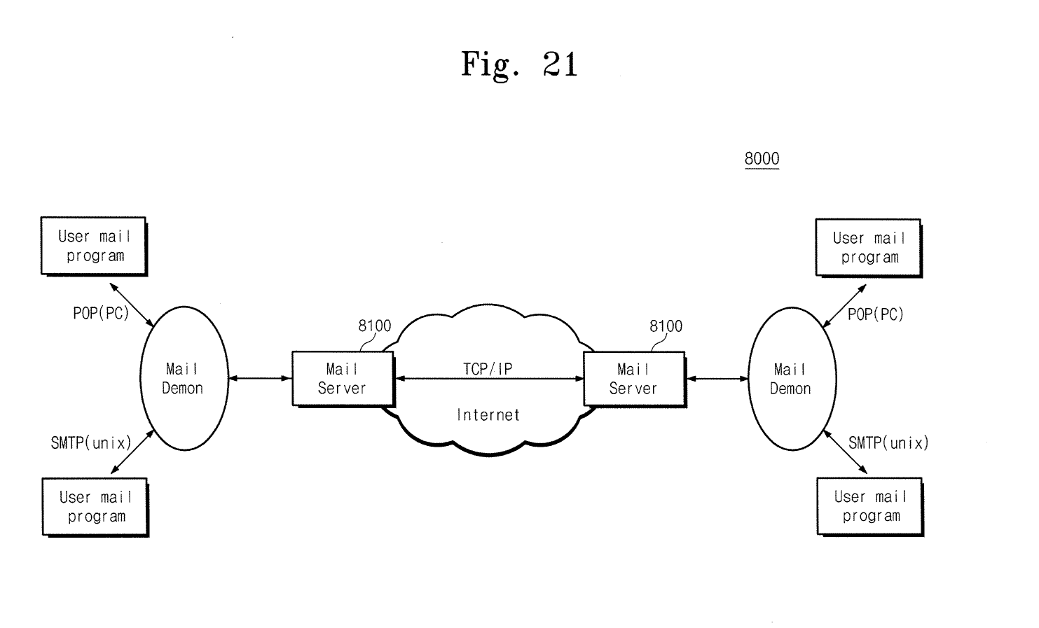

In the event that a solid state drive including a data storage device according to exemplary embodiments of the inventive concept is applied to a storage, as illustrated in FIG. 19, a system 6000 includes a storage 6100 which communicates with a host by a wire or wireless communication manner. In a case where a solid state drive including a data storage device according to exemplary embodiments of the inventive concept is applied to a storage server, as illustrated in FIG. 20, a system 7000 includes a storage servers 7100 and 7200 which communicate with a host by a wire or wireless communication manner. Further, as illustrated in FIG. 21, a solid state drive including a data storage device according to exemplary embodiments of the inventive concept can be applied to a mail server 8100.

In an exemplary embodiment, a compression block 2500 of a controller 2000 may include one of the following compression algorithms or a combination of two or more compression algorithm. Compression algorithms may includes LZ77&LZ78, LZW, Entropy encoding, Huffman coding, Adpative Huffman coding, Arithmetic coding, DEFLATE, JPEG, etc.

In an exemplary embodiment, the first interface 2100 of a controller 2000 may be formed of one of computer bus standards, storage bus standards, and iFCPPeripheral bus standards, or a combination of two or more standards. The computer bus standards may includes S-100 bus, Mbus, Smbus, Q-Bus, ISA, Zorro II, Zorro III, CAMAC, FASTBUS, LPC, EISA, VME, VXI, NuBus, TURBOchannel, MCA, Sbus, VLB, PCI, PXI, HP GSC bus, CoreConnect, InfiniBand, UPA, PCI-X, AGP, PCIe, Intel QuickPath Interconnect, Hyper Transport, etc. The storage bus standards may include ST-506, ESDI, SMD, Parallel ATA, DMA, SSA, HIPPI, USB MSC, FireWire(1394), Serial ATA, eSATA, SCSI, Parallel SCSI, Serial Attached SCSI, Fibre Channel, iSCSI, SAS, RapidIO, FCIP, etc. The iFCPPeripheral bus standards may include Apple Desktop Bus, HIL, MIDI, Multibus, RS-232, DMX512-A, EIA/RS-422, IEEE-1284, UNI/O, 1-Wire, I2C, SPI, EIA/RS-485, USB, Camera Link, External PCIe, Light Peak, Multidrop Bus, etc.

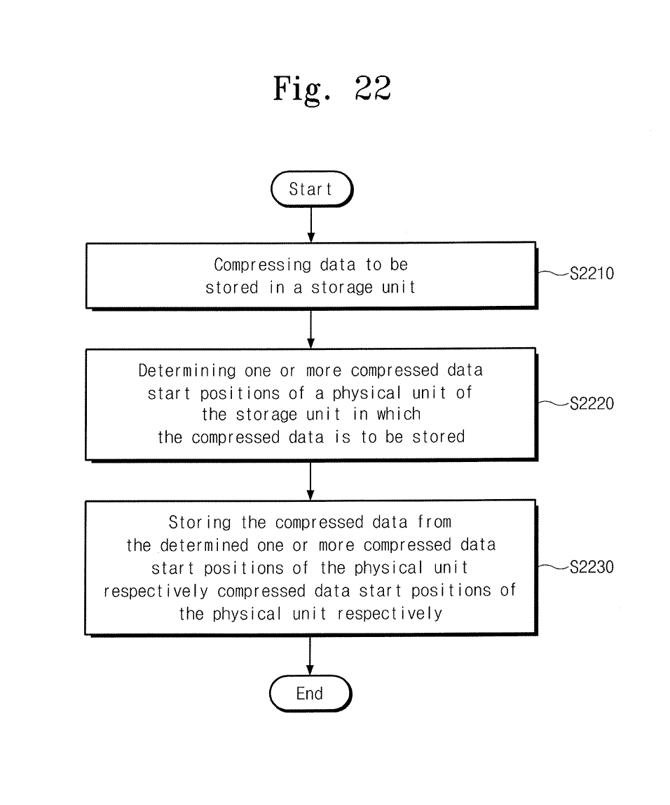

FIG. 22 is a flowchart illustrating a method of a data storage system. Referring to FIG. 22, the system compresses data to be stored in a storage media in operation S2210. The system determines one or more data start positions of a physical unit of the storage media in which the compressed data is to be stored in operation S2220. The system stores the compressed data from the determined one or more compressed date starting positions of the physical unit, respectively, in operation S2230.

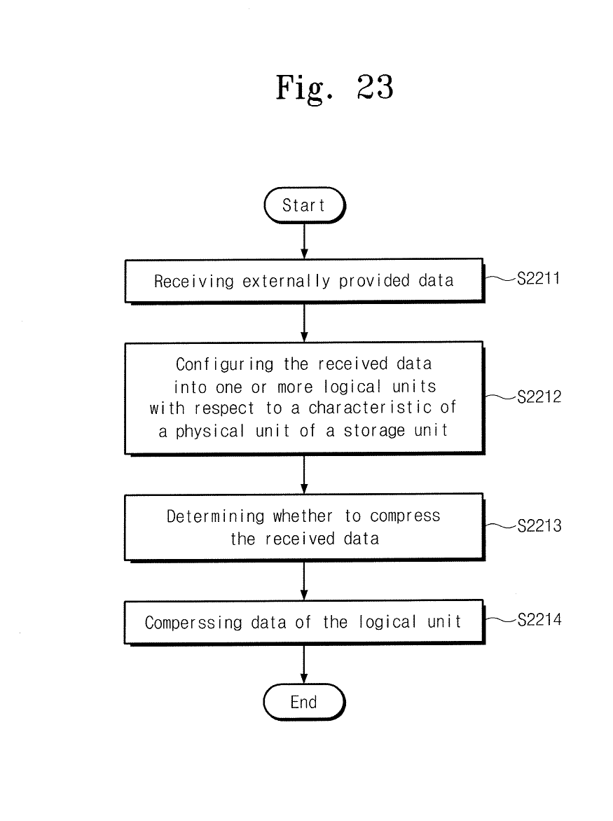

FIG. 23 is a flowchart illustrating the operation S2210 of FIG. 22. Referring to FIGS. 22 and 23, the system receives data provided from an external device in operation S2211. The system configures the received data into one or more logical units with respect to a characteristic of a physical unit of a storage media in operation S2212. The system determines whether to compress the received data according to a characteristic of the received data or a space to compress or store the received data, for example, in operation S2213. The system compresses the data of one or more logical units to be stored in a physical unit in operation S2214.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A write method of a data storage device including a storage media, the write method comprising:
compressing data of one or more logical units to be stored in the storage media;
determining compressed data start positions of a physical unit of the storage media in which the compressed data is to be stored; and
storing the compressed data from the determined compressed data start positions of the physical unit, respectively.

2. The write method of claim 1, wherein the physical unit of the storage media has at least two compressed data start positions.

3. The write method of claim 2, wherein segments of the physical unit defined by the compressed data start positions have the same size.

4. The write method of claim 3, wherein the compressed data start positions are assigned sequentially regardless a size of the compressed data.

5. The write method of claim 2, wherein segments of the physical unit defined by the compressed data start positions have different sizes from one another.

6. The write method of claim 5, wherein the compressed data start positions are assigned randomly according to a size of compressed data.

7. The write method of claim 1, wherein the determining compressed data start positions of the physical unit of the storage media in which the compressed data is to be stored, comprises configuring a mapping table entry, the mapping table entry including chip information, block information, physical unit information, compressed data start position information, and compressed data length information.

8. The write method of claim 7, wherein compressed data stored in the physical unit of the storage media is read based on the compressed start position information and the compressed data length information.

9. The write method of claim 1, wherein the compressing data to be stored in the storage media comprises adding an end mark indicative of an end of the compressed data to be stored in the physical unit of the storage media.

10. The write method of claim 9, wherein the determining compressed data start positions of the physical unit of the storage media in which the compressed data is to be stored, comprises configuring an mapping table entry with respect to the compressed data, the mapping table entry including chip information, block information, physical unit information, and compressed data start position information.

11. The write method of claim 10, wherein compressed data stored in the physical unit of the storage media is read based on the compressed data position information and the end mark.

12. The write method of claim 1, wherein the compressing data to be stored in the storage media comprises:
receiving externally provided data;
configuring the received data into logical units, each logical unit being less or identical in size than or to a physical unit of the storage media; and
compressing data of each logical unit.

13. The write method of claim 12, wherein the received data is provided according to one or more external write requests.

14. A data storage device comprising:
a storage media; and
a controller configured to compress data of one or more logical units to be stored in a physical unit of the storage media,
wherein the controller compresses the data to be stored in the physical unit the storage media so that a size of the compressed data is fitted to a size of the physical unit of the storage media.

15. The data storage device of claim 14, wherein:
the controller configures a mapping table entry with respect to the compressed data, the mapping table entry including chip information, block information, first physical unit information, second physical unit information, and offset information; and
when data of first and second logical units is stored in a first physical unit, the offset information being indicative of a start position of data of the second logical unit.

16. A data storage device comprising:
a storage media; and
a controller configured to compress data to be stored in the storage media,
wherein the controller determines compressed data start positions of a physical unit of the storage media in which the compressed data is to be stored, and controls the storage media to store the compressed data from the determined compressed data start positions of the physical unit, respectively.

17. The data storage device of claim 16, wherein the controller configures a mapping table entry with respect to the compressed data, the mapping table entry including chip information, block information, physical unit information, compressed data start position information, and compressed data length information.

18. The data storage device of claim 16, wherein the controller is configured to add an end mark to the compressed data, the end mark being indicative of an end of the compressed data.

19. The data storage device of claim 18, wherein the controller configures a mapping table entry with respect to the compressed data, the mapping table entry including chip information, block information, physical unit information, and compressed data start position information.

20. The data storage device of claim 19, wherein compressed data stored in a physical unit of the storage media is read based on the compressed data start position information and the end mark.

21. A data storage device comprising:
a storage media; and
a controller configured to compress data of one or more logical units to be stored in a physical unit of the storage media,
wherein the controller compresses the data to be stored in the physical unit the storage media so that a size of the compressed data is fitted to a size of the physical unit of the storage media, determines compressed data start positions of the physical unit of the storage media in which the compressed data is to be stored, and controls the storage media to store the compressed data from the determined compressed data start positions of the physical unit, respectively.

22. A data storage device comprising:
a storage media; and
a controller configured to receive data of a plurality of logical units, assign the plurality of logical units to a physical unit of the storage media, compress the data of the plurality of logical units, and control the storage medial to store the compressed data of the logical units in the physical unit of the storage media.

23. The data storage device of claim 22, wherein the controller determines a plurality of starting positions to start the storing of the compressed data of the plurality of logical units within the physical unit of the storage media.

24. The data storage device of claim 22, wherein the controller includes a mapping table having information on locations of the physical unit to correspond to the compressed data of the plurality of the logical units.

25. The data storage device of claim 22, wherein, when each of the plurality of the logical units is formed in a unit of a page, and the physical unit is formed in the unit of the page, the physical unit stores a plurality of pages corresponding to the compressed data of the plurality of logical units.
